(19) United States
(12) Patent Application Publication
(10) Pub. No.: US 2009/0201219 A1
(43) Pub. Date: Aug. 13, 2009

(54) Antenna Integrated with speaker

(76) Inventors: Byung Hoon Ryou, Seoul (KR); Won Mo Sung, Gyeonggi-do (KR); Seok Mok Yang, Chungcheongnam-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/308,806

(22) PCT Filed: Jul. 13, 2007
(86) PCT No.: PCT/KR2007/003399

§ 371 Date: Apr. 9, 2009

(30) Foreign Application Priority Data
Jul. 13, 2006 (KR) 20-2006-0019014

(51) Int. Cl. H01Q 1/00

(52) U.S. Cl. 343/904

(57) ABSTRACT

The present invention relates to an assembled structure of an antenna and a speaker built in a wireless communication terminal, and more particularly, to an antenna integrated with speaker in which an antenna and a speaker are integrated into a single module. The present invention provides an antenna integrated with speaker comprising: an antenna carrier including an upper frame and a lower frame which are coupled to each other, the upper frame having a radiator mounted thereon; and a speaker mounted at the antenna carrier, wherein the speaker is coupled to a mounting hole formed at the lower frame through a coupling means from the outside of the antenna carrier. It is possible to obtain an effect of minimizing defect and loss of a speaker which may occur during the assembly of the antenna to thereby maximize efficiency of production.

### TECHNICAL FIELD

The present invention relates to an assembled structure of an antenna and a speaker built in a wireless communication terminal, and more particularly, to a combined antenna and speaker in which an antenna and a speaker are integrated into a single module.

### BACKGROUND ART

A mobile communication service increasingly follows a trend toward high-speed and large-capacity multimedia so as to satisfy the desires of consumers. Also, the technology of a terminal that provides such a mobile communication service is being advanced in conformance with integration, compactness, lightness and the like of components.

Particularly, an antenna playing a very important role in determining the performance of the terminal, there is a need for an intenna, i.e., an antenna which is embedded in the terminal in terms of convenience of use and design. An antenna is widely used in which is modulized by integrally coupling a speaker to such an intenna.

For example, as shown in FIG. 1, an intenna module for a portable wireless terminal disclosed in Korean Patent Laid-Open Publication No. 2006-43703 is constructed such that a speaker 30 is embedded at a mounting portion 21 formed at a predetermined position at an inside of a lower frame 20 thereof, and then an upper frame 10 and the lower frame 20 are bonded to each other by means of ultrasonic welding or gluing while coming into close contact with each other.

However, such coupling between the antenna and the speaker by means of the ultrasonic welding entails a problem in that an ultrasonic wave generated in the process of the ultrasonic welding adversely affects the sound quality, etc., of the speaker to lead thereby to defect of the speaker and degradation of quality of a finished product, as well as introduction of separate ultrasonic welding equipment increases the production cost to thereby deteriorate productivity.

Meanwhile, such coupling between the antenna and the speaker by means of the gluing entails another problem in that it is significantly difficult to evenly apply a glue on a bonded portion between the antenna and the speaker, and gas harmful to the human body is emitted from the glue as well as the outer appearance of the antenna is poor. Thus, a separate process is required which washes the outer appearance of the antenna, etc., so that the production time is excessively consumed.

Korean Registration Utility Model No. 413415 (hereinafter, referred to as ‘prior application invention’) which was filed by this applicant and was registered discloses a technique in which a sound absorption material is interposed between an upper frame and a lower frame and a coupling is achieved therebetween by using a hook, etc., which is incorporated herein by reference in its entirety.

### DISCLOSURE OF INVENTION

### Technical Problem

Accordingly, the present invention has been made to solve the above-mentioned problems occurring in the prior art in an approach manner which is different from but compatible to the prior application invention, and it is an object of the present invention to provide an antenna integrated with speaker which can minimize defect and loss of a speaker which may occur during the assembly of the antenna as well as can secure easiness of the assembly to maximize efficiency of production.

### Technical Solution

To accomplish the above object, according to the present invention, there is provided an antenna integrated with speaker comprising: an antenna carrier including an upper frame and a lower frame which are coupled to each other, the upper frame having a radiator mounted thereon; and a speaker mounted at the antenna carrier, wherein the speaker is coupled to a mounting hole formed at the lower frame through a coupling means from the outside of the antenna carrier.

### Advantageous Effects

According to the antenna of the present invention as described above, since the upper frame and the lower frame of the antenna carrier are coupled to each other, and then the antenna carrier and the speaker are coupled to each other, it is possible to obtain an effect of minimizing defect and loss of a speaker which may occur during the assembly of the antenna using ultrasonic welding, etc.

In addition, the present invention has an advantageous effect in that since the antenna carrier and the speaker are easily coupled to each other through a detachable coupling means, only the speaker can be easily removed for re-use although defectives are produced due to an erroneous assembly during the manufacturing process, thereby greatly reducing the number of processes such as a complex separation process, etc., to improve workability and productivity, and greatly contributing to reduction in the manufacturing cost of the antenna and quality promotion.

### BRIEF DESCRIPTION OF THE DRAWINGS

[symbol] conventional combined antenna and speaker according to the prior art;

FIG. 2 is an exploded perspective view showing an antenna integrated with speaker according to an embodiment of the present invention;

FIG. 3 is a bottom exploded perspective view showing an antenna integrated with speaker according to an embodiment of the present invention;

FIG. 4 is an assembled perspective view of an antenna integrated with speaker of FIG. 3; and

FIG. 5 is a top plan view showing a lower frame of the an antenna integrated with speaker according to an embodiment of the present invention.

### BEST MODE FOR CARRYING OUT THE INVENTION

Reference will now be made in detail to a preferred embodiment of the present invention with reference to the attached drawings.

Elements having the same function in all the figures of the accompanied drawing use identical reference numerals for the sake of avoiding their repeated explanation. Terminologies which will be described are defined in view of the function a corresponding element in the present invention, which specifies the fact that they should be construed as concepts conforming to the technical spirit of the present invention and intrinsic meanings typically used.

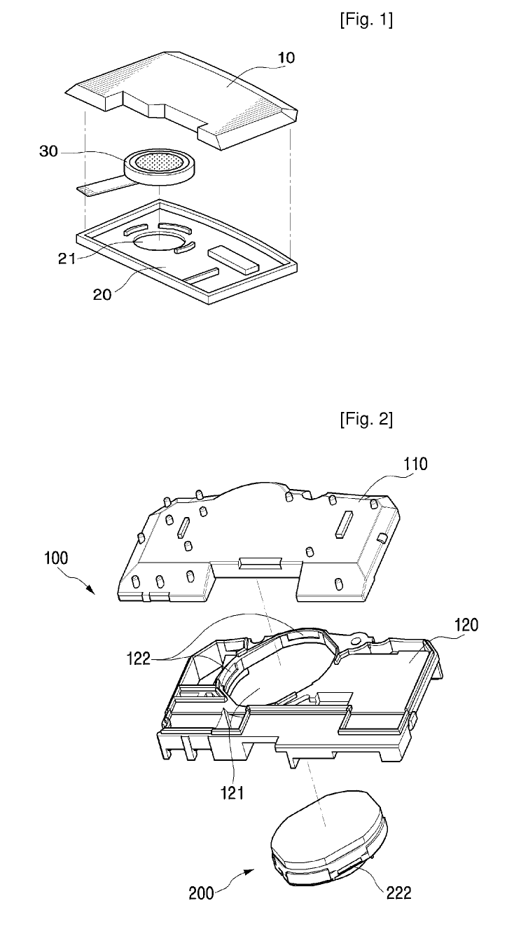

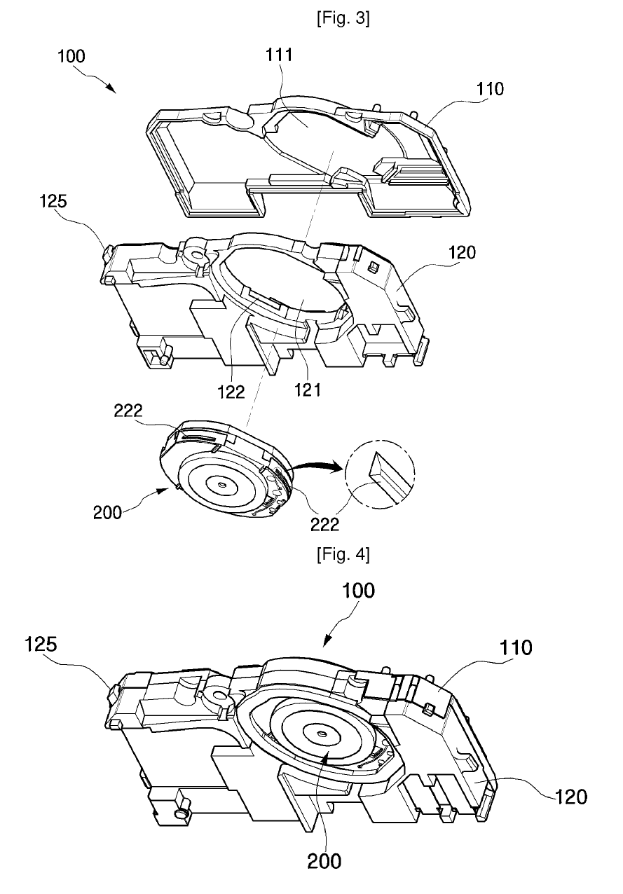

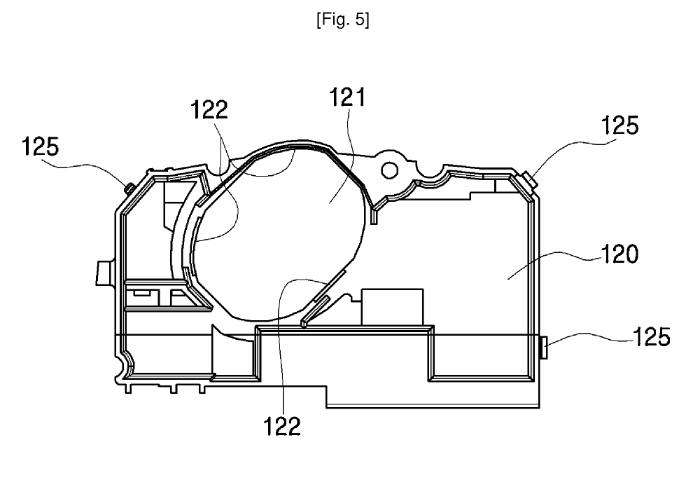

FIG. 2 is an exploded perspective view showing an antenna integrated with speaker according to an embodiment of the present invention, FIG. 3 is a bottom exploded perspective view showing an antenna integrated with speaker according to an embodiment of the present invention, FIG. 4 is an assembled perspective view of an antenna integrated with speaker of FIG. 3, and FIG. 5 is a top plan view showing a lower frame of the antenna integrated with speaker according to an embodiment of the present invention.

As shown in FIGS. 2 to 5, an antenna integrated with speaker according to an embodiment of the present invention comprises an antenna carrier 100 including an upper frame 110 and a lower frame 120, and a speaker 200 coupled to the antenna carrier through a coupling means.

First, the antenna carrier 100 is made of a dielectric material and includes a radiator (not shown) for transmitting and receiving an electromagnetic wave. That is, the antenna carrier 100 includes the upper frame 110 and the lower frame 120 which are coupled to each other for performing a function of a resonant cavity of the speaker 200 within a range which does not hinder am intrinsic function of an antenna. In this case, the upper frame 110 may have a radiator (not shown) mounted on a top surface thereof.

The upper frame 110 has a seating recess 111 formed on the underside thereof so as to ensure a more rigid and stable coupling between the speaker 200 and the antenna carrier 100 when the speaker 200 is combined to the upper frame 110

In addition, the lower frame 120 has a mounting hole 121 penetratingly formed at a given position thereof so as to fit and mount the speaker 200 thereto. In this case, the lower frame 120 has a plurality of guide projections 125 formed at a peripheral edge thereof so as to ensure a rapid and easy coupling between the upper frame 110 and the lower frame 120.

The upper frame 110 and the lower frame 120 can be bonded to each other by means of ultrasonic welding or gluing, or by means of interposition of a sound absorption material between the upper frame 110 and the lower frame 120 as disclosed in the aforementioned prior application invention while coming into close contact with each other.

The speaker 200 is a typical one mounted at a wireless communication terminal, and is configured to be coupled to the antenna carrier 100 through the mounting hole 121. That is, the speaker 200 can be fittingly coupled to the mounting hole 121 of the lower frame 120 from the outside of the antenna carrier after the coupling between the upper frame 110 and the lower frame 120.

As a coupling means for stably coupling the antenna carrier 100 and the speaker 200 to each other, coupling grooves 122 and coupling projections 222 are formed at the antenna carrier 100 and the speaker 200, respectively, so as to be correspondingly coupled to each other. That is, a plurality of coupling projections 222 are formed on the outer circumferential edge of the speaker 200, and a plurality of coupling grooves 122 are formed on the inner circumferential edge of the mounting hole 121, so that the coupling projections 222 can be fittingly coupled to the coupling grooves 122.

Thus, the antenna carrier 100 and the speaker 200 can be detachably mounted to each other in a rapid and easy manner.

Herein, the coupling projections 222 are preferably formed in the shape of a hook, wedge, etc., so as to ensure that the coupling projections 222 and the coupling grooves 122 do not move but are maintained in a rigid and stable state when being coupled to each other.

Meanwhile, the coupling projections 222 and the coupling grooves 122 have been described as a preferred coupling means according to the present invention, but besides these, any means can be used which can allows easy coupling and decoupling therebetween, and hence is suitable for accomplishment of the object of the present invention and permits those skilled in the art to carry out the invention.

The present invention according to this embodiment is modulized by integrally coupling a speaker 200 to the antenna carrier 100, so that compactness of mobile communication devices including cellular phones is achieved as well as the antenna carrier 100 is not limited in shape to the speaker 200 to thereby increase a degree of freedom of design of the antenna, and so that the assembly process of the antenna carrier 100 and the speaker 200 is simplified to thereby reduce the manufacturing cost and time.

Furthermore, since the speaker 200 can be coupled to antenna carrier 100 through the mounting hole 121 formed at the lower frame 120 from the outside of the antenna carrier 100 after the coupling between the upper frame 110 the lower frame 120 of the antenna carrier 100 is achieved, defect and loss of a speaker can be minimized which may occur during the ultrasonic welding, etc.

Moreover, since the speaker 200 is detachably coupled to the antenna carrier 100, only the speaker 200 is removed from the antenna carrier 100 for re-use even through a defect occurs in the antenna carrier 100, thereby reducing the manufacturing cost.

While the invention has been described in connection with what is presently considered to be practical exemplary embodiments, it is to be understood that the invention is merely exemplary and not limited to the disclosed embodiments. Therefore, a person skilled in the art can perform various changes and modifications based on a principle of the present invention, which falls in the scope of the present invention. Therefore, the scope of the present invention should not be construed as being limited to the above described embodiment, but should be defined by the appended claims and the equivalents to the claims.

1. An antenna integrated with speaker comprising: an antenna carrier including an upper frame and a lower frame which are coupled to each other, the upper frame having a radiator mounted thereon; and a speaker mounted at the antenna carrier, wherein the speaker is coupled to a mounting hole formed at the lower frame through a coupling means from the outside of the antenna carrier.

2. The antenna integrated with speaker according to claim 1, wherein the coupling means is configured such that the speaker is detachably coupled to the antenna carrier.

3. The antenna integrated with speaker according to claim 1, wherein the coupling means comprises coupling projections formed at the speaker and coupling grooves formed at the antenna carrier.

4. The antenna integrated with speaker according to claim 1, wherein the coupling means comprises one or more coupling projections formed on the outer circumferential edge of the speaker, and one or more coupling grooves formed on the inner circumferential edge of the mounting hole formed at the lower frame, so that the coupling projections can be fittingly coupled to the coupling grooves.
